(19) United States
(12) Patent Application Publication
(10) Pub. No.: US 2002/0178757 A1
(43) Pub. Date: Dec. 5, 2002

(54) Calculation of modes in cylindrically-symmetric optical fiber

(76) Inventor: Stephen R. Chinn, Westford, MA (US)

Correspondence Address: William G. Auton, ESC/JAZ, 40 Wright Street, Hanscom AFB, MA, 01731-2903, US

(21) Appl. No.: 09/866,087

(22) Filed: May 29, 2001

(51) Int. Cl. C03B 37/07

(52) U.S. Cl. 65/378

(57) ABSTRACT

A semi-analytic numerical method and one software reduction to practice of a means of finding the eigenmodes of optical fiber that has cylindrical symmetry. This includes fibers that have a radially varying index of refraction that can be described or approximated by one or more cylindrical layers of constant index of refraction.

One advantage is that the method provides a small set of numerical coefficients (four per layer) used for analytic evaluation of fields and intensities. Mode properties such as optical confinement (overlap) factors in any of the layers can be easily evaluated in terms of these coefficients and analytic expressions for Bessel function integrals.

### STATEMENT OF GOVERNMENT INTEREST

The invention described herein may be manufactured and used by or for the Government for governmental purposes without the payment of any royalty thereon.

### BACKGROUND OF THE INVENTION

The present invention relates generally to optical fiber fabrication processes and more specifically to a process for finding, the eigenmodes of optical fiber that has cyllindrical symmetry. This includes fibers that have a radially varying index of refraction that can be described or approximated by one or more cylindrical layers of constant index of refraction.

Optimum designs of optical fiber index profiles can be deduced with the aid of computer-aided modeling studies as those outlined by T. A. Lenahan in an article entitled “Calculation of Modes in an Optical Fiber Using, the Finite Element Method and EISPACK” published in The Bell System Technical Journal, Vol. 62, No. 9, pp. 2663- 2694 (November 1983), which is incorporated herein by reference. This information was used in fiber optic design, as shown in U.S. Pat. No. 4,552,578 by Anderson entitled “Optical fiber fabrication process comprising determining mode field radius and cut-off wavelength of single mode optical fibers”, which is also disclosed herein by reference.

Another known technique for finding electromagnetic modes of stratified planar dielectric media, known as the transfer-matrix method was documented by C. Yeh and G. Lindgren in “Computing the propagation characteristics of radially stratified fibers: an efficient method,” Applied Optics, Vol. 16, No. 2, pp. 483-493 (February 1977). In this technique, the fields at one side of a uniform dielectric layer are related to those at the other side by general analytic plane-wave solutions of Maxwell's equations. The fields across layer boundaries are related by material boundary conditions, generally the continuity of tangential field components in source-free media. By sequential applications of the analytic solution and boundary conditions, an overall field propagation matrix can be found as the product of individual layer matrices. The final bound mode solutions result from application of the boundary conditions (fields vanishing at infinity) at the outer layers, and subsequent solution of the resulting determinantal equation as a function of an unknown frequency or propagation factor. For stratified planar layers, fields are either transverse electric (TE) or transverse magnetic (TM) and all matrices and the final determinant are size 2×2.

The same concept needs to be extended to cylindrically-symmetric (round) optical fibers. The present invention is intended to satisfy that need.

### SUMMARY OF THE INVENTION

The present invention is a direct improvement of the optical fiber fabrication process of the above-cited Anderson patent. It uses many of the same process steps but uses the Bessel function to determine the optical fiber modes for a cylindrical fiber. One embodiment entails a cylindrical optical fiber manufacturing process comprising a multiplicity of manufacturing steps including forming a first optical fiber preform, drawing a first fiber from the first preform and grading of the drawn fiber, the process further comprising

Determining the mode field radius ω for radiation of wavelength λ₀ of a segment of the first fiber, λ₀ being a wavelength in the single mode regime of the segment of the fiber the fiber segment having a first and second end and being of length effective to produce steady-state propagating conditions at the second end for radiation of wavelength λ₀ launched into the first end;

Comparing ω to a predetermined target value of the mode field radius; and

Setting at least one of the manufacturing steps in the manufacture of the first fiber, setting of at least one of the manufacturing steps for the subsequent production of another optical fiber, in accordance with the result of the comparison between ω and the target value;

The mode field radius ω determined by a method comprising

(a) coupling substantially monochromatic measurement radiation of wavelength λ₀ into the first end of the fiber segment in a manner effective for launching the fundamental mode LP₀₁.

(b) measuring, as a function of a far-field angle θ, the radiation power at a multiplicity of values of θ in at least part of the central lobe of the far-field radiation field of the radiation emitted from the second end of said first fiber, the set of measured values of radiation power to be referred to as the radiation power distribution,

(c) fitting a Bessel function to the radiation power distribution, or to a distribution derived from the radiation power distribution, and

(d) determining ω from the fitted Bessel function.

### DESCRIPTION OF THE DRAWINGS

FIG. 1 shows prior art experimentally determined curves of far-field power;

FIG. 2 schematically depicts apparatus useful for determination of λ_{c} and or ω according to the prior art;

FIG. 3 shows further prior art apparatus for the practice of the invention; and

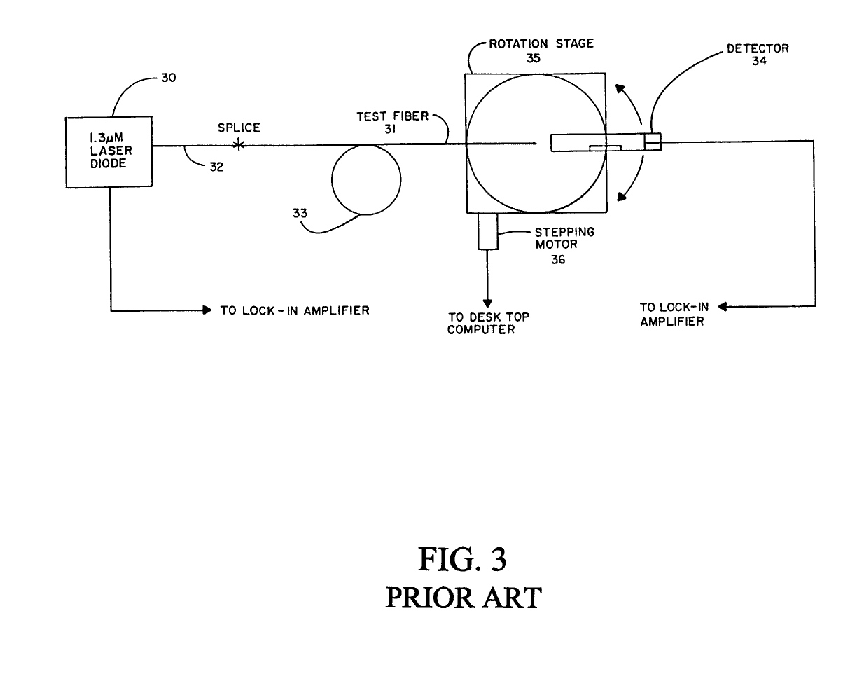

FIG. 4 shows exemplary curves of beam angle versus wavelength, as determined by the inventive method.

### DESCRIPTION OF THE PREFERRED EMBODIMENT

The discussion of the present invention describes a semi-analytic numerical method and one software reduction to practice of a means of finding the eigenmodes of optical fiber that has cylindrical symmetry. This includes fibers that have a radially varying index of refraction that can be described or approximated by one or more cylindrical layers of constant index of refraction.

The concept is an extension of a technique frequently applied to finding electromagnetic modes of stratified planar dielectric media, know as the transfer-matrix method. In this technique, the fields at one side of a uniform dielectric layer are related to those at the other side by general analytic plane-wave solutions of Maxwell's equations. The fields across layer boundaries are related by material boundary conditions, generally the continuity of tangential field components in source-free media. By sequential applications of the analytic solution and boundary conditions, an overall field propagation matrix can be found as the product of individual layer matrices. The final bound mode solutions result from application of the boundary conditions (fields vanishing at infinity) at the outer layers, and subsequent solution of the resulting determinantal equation as a function of an unknown frequency or propagation factor. For stratified planar layers, fields are either transverse electric (TE) or transverse magnetic (TM ) and all matrices and the final determinant are size 2×2.

The same concept can be extended to cylindrically-symmetric (round) optical fibers. In general, the TE and TM modes are coupled into hybrid (HE,EH) modes although TE and TM modes also exist. The plane wave solutions are replaced in cylindrical symmetry by Bessel functions, and four tangential field components must be found and matched at the boundaries, resulting in 4×4 matrices. This is the general method that is used in the invention described herein. The implementation was performed using C-like code in a graphical display and analysis application, ‘Igor Pro’ from Wavemetrics, Inc. This was chosen because of its ease of creating the graphical user interface and its integrated computation and display capability. Any other software development environment having access to algorithmic coding, high-precision function evaluation, and user interface integration could be used.

The first improvement over similar published methods for fibers is the use of scaled magnetic field variables, by which the tangential magnetic fields are multiplied by J×Z₀, where j=\sqrt{−1} and Z₀ is the characteristic impedance of free space. Such scaling results in all field variables becoming real-valued with common dimensions. This avoids the need for complex (real, imaginary) numerical calculations, thereby simplifying analytic calculations, reducing numeric computation storage, and increasing computation speed. This improvement in computational performance is significant, because it means that fibers with many thin layers approximating a continuous distribution can be quickly evaluated with modest, desk-top PC computer resources. This method gives exact, full-vectorial (hybrid) solutions as opposed to frequently used simpler methods employing a scalar approximation. Unlike Yeh and Lehman's method, it also incorporates TE and TM solutions as well as the hybrid HE, EH modes.

The second improvement is algorithmic, and relates to an analytic test that can be applied to eliminate a spurious root of the eigenvalue equation that may occur in an unusual circumstance where the index profile has a local minimum meeting certain conditions.

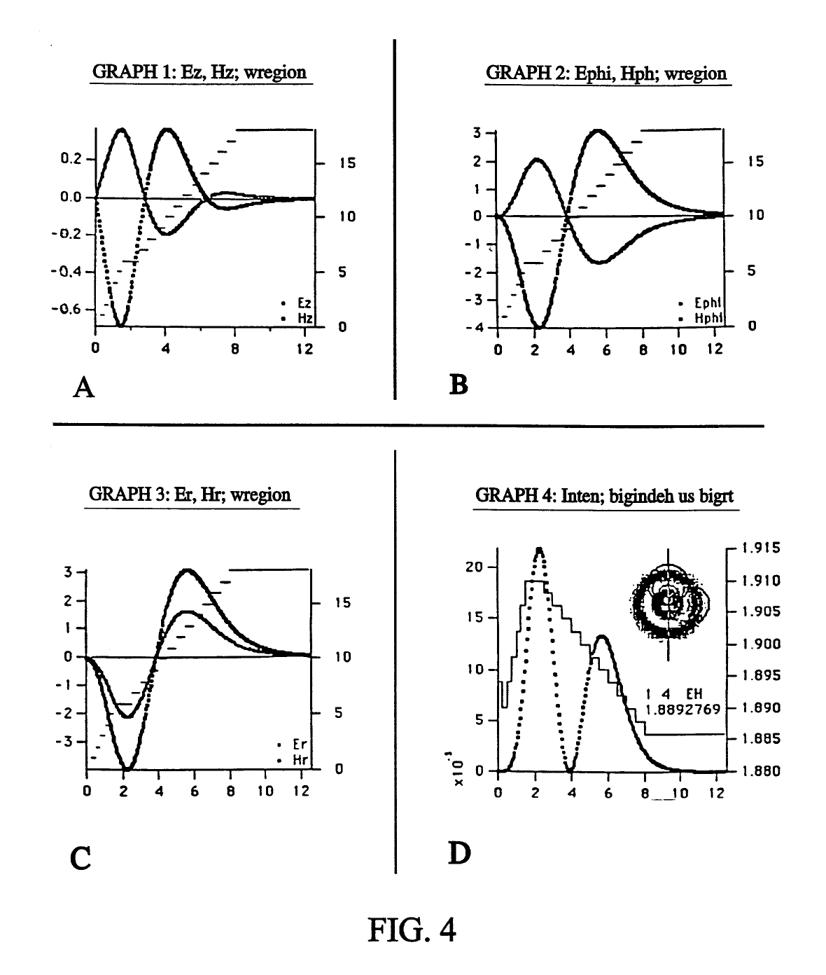

The third improvement is incorporation of a graphical user interface, whereby data input describing the fiber parameters, optical wavelength, and solution type may be entered interactively, and output description of the mode occurs as field/intensity profiles and image plots rather than stored data files (which may also be implemented). An example of the user's computer screen is shown by FIGS. 4a-4d. The upper windows (FIGS. 4a,4b and 4c) show the field component profiles, FIG. 4d shows the mode intensity profile, index profile and intensity and polarization images, and the lower right window shows the graphical display of the determinant and root evaluation (4^{th}, highest root illustrated).

A fourth advantage is that the method provides a small set of numerical coefficients (four per layer) used for analytic evaluation of fields and intensities. Mode properties such as optical confinement (overlap) factors in any of the layers can be easily evaluated in terms of these coefficients and analytic expressions for Bessel function integrals.

The following discussion is presented to fully describe the mathematics of finding the modes of an optical fiber. As discussed in the Anderson patent cited above, the art knows several techniques for measuring the mode and the cut off wavelength, but they generally fall into one of two classes.

Techniques in the first class rely upon the fact that more optical power can be launched into an overfilled fiber core when higher order modes can propagate than when only the fundamental mode propagates. Thus a substantial decrease in the power transmitted through a fiber is observed at the cut-off wavelength. Such a measurement can be implemented in at least two ways. First, the loss of a fiber can be measured with or without a “mode-stripping” bend in the fiber, (e.g., an about one-inch diameter loop), and the wavelength above, in which the results of two measurements converge can be identified. See, for instance, Y. Katsuyama et al., Electronic Letters, Vol. 12 (25), pp. 669-670 (1976). Second the amount of power launched into a short, e.g. about 1 meter long, fiber, whose loss is negligible may be measured directly. Se, for instance, the paper by P. D. Lazay in Technical Digest, Symposium on Optical Fiber Measurements, Boulder, Colo., October 1980, pp. 93-95. Both these approaches have shortcomings. In the former technique there exists ambiguity as to whether the observed cut-off is the desired single mode transition, the technique is complicated by fiber loss and mode coupling, and is unsuited for measuring fibers of length greater than about 10 mm. The practice of the latter technique requires a high quality monochromator to yield a smooth launching spectrum. Such an instrument is costly and not well suited to function in a production environment.

The second class of cut-off wavelength measurement techniques uses measurement of the near- or far-field of a fiber. Since the fundamental mode and the higher order modes have substantially different near-field and far-field patterns, the presence of higher order modes can, in principle, be detected. The cut-off wavelength can then be identified as that wavelength above which no higher order mode is present.

The Anderson patent indicated that the art also knows several techniques for determining the MFR of single mode fiber. For instance, one such technique requires focusing a greatly magnified image of the illuminated fiber core into a television vidicon Another technique utilizes the sensitivity of splice loss to transverse offset of the coupled fibers to determine the spot size (J. Streckert, Optics Letters, Vol. 5(12), page 505 (1980). Other techniques require measurement of the far-field radiation field, with computation of either core parameters or the near-field radiation distribution and index profile from the measured pattern.

Anderson indicated that the radiation field in a waveguide, in particular, in an optical waveguide, i.e. a fiber, can be expressed in terms of radiation modes. Whether or not a certain mode can propagate in a fiber depends, for a particular fiber, on the wavelength of the radiation. The lowest order propagating mode LP₀₁ does not have a cut-off wavelength. On the other hand, the next higher mode, designated LP₁₁, , can, according to theory, not propagate in step index fiber if V<2.405, where V =ka(n₁² - n₀²)^{½}. In this expression, no and n1 are the refractive indices of the cladding and the core, respectively, a is the core diameter, and k is the wave propagation constant in a vacuum. The theoretical cut-off wavelength in this case is determined by V =2.405. However, it is observed in real fibers that the LP₁₁, mode ceases to propagate over macroscopic distances at a wavelength that is typically shorter than the theoretical cut-off wavelength. This wavelength is the effective cut-off wavelength λ_{c}.

The far-field radiation pattern, produced by a localized radiation source, that exists at distances from the source much greater than the radiation wavelength and source dimension, is the “far-field”. For the wavelengths of interest herein, typically between about 0.8 μm and about 1.6 μm, the far-field radiation distribution is well established at distances from the radiating fiber end greater than 1 mm. For practical purposes, however, the source-to-detector distance advantageously is chosen to be substantially .greater than this, e.g. of the order of about 1 to 10 cm, to achieve appropriate angular resolution.

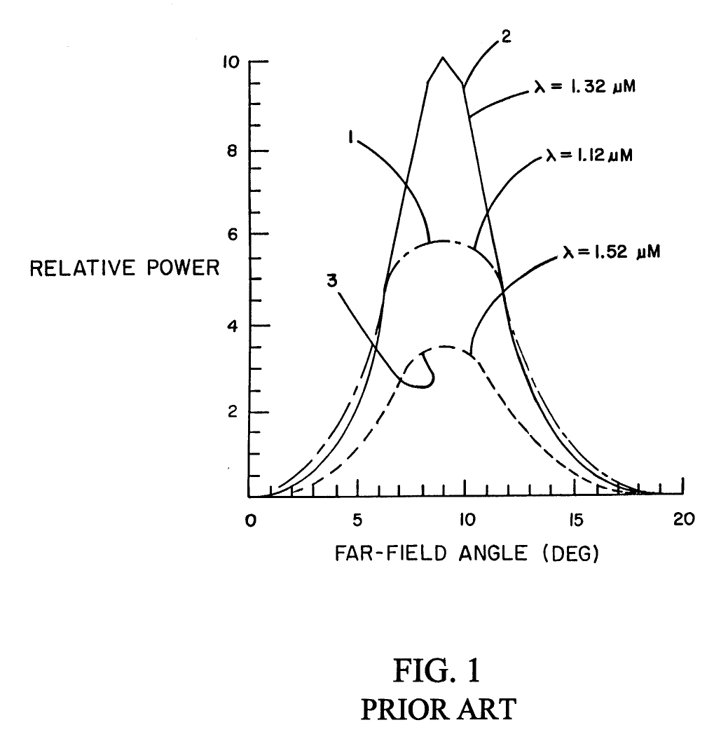

It is well known that the radial power distribution in the far-field regime changes drastically with wavelength near λ_{c}. This is illustrated by means of exemplary experimentally determined curves in FIG. 1. Curve 1 shows the relative power of radiation emitted from the end of a single mode fiber segment as a function of the far- field angle, at a wavelength much below λ_{c}; curve 2 shows the same for a wavelength close to, but still below λ_{c}; curve 3 shows the same at a wavelength greater than λ_{c}.

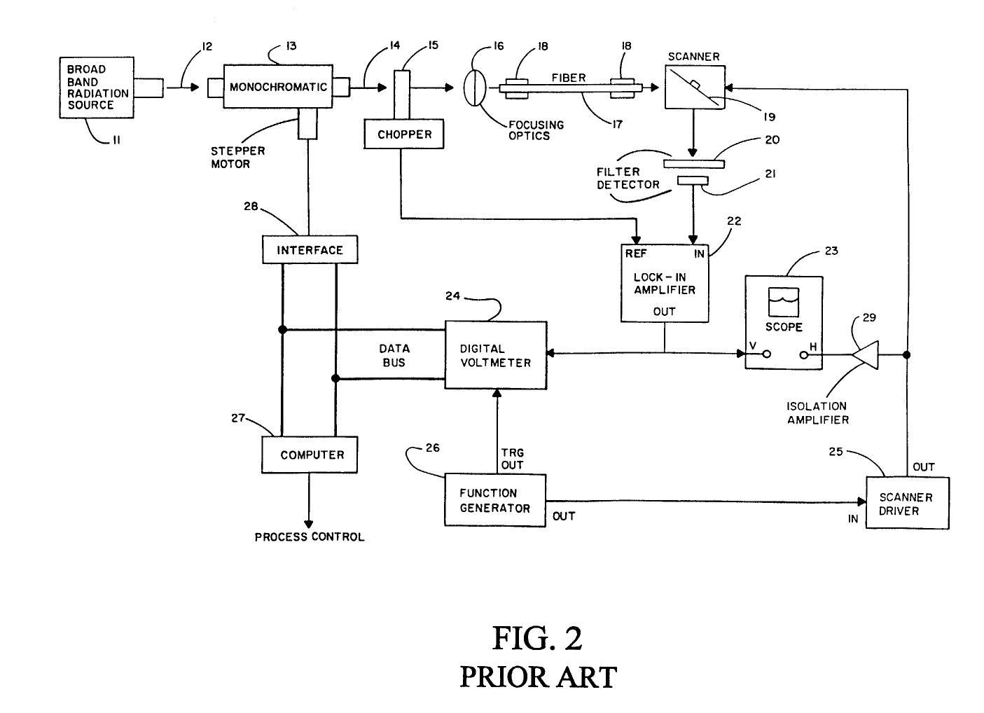

Exemplary instrumentation for determining the far-field radiation power, as well as for carrying out some data processing, to be discussed below, on the measured data, is shown in FIG. 2. Broadband radiation source II, e.g. a 100 watt tungsten-halogen lamp, produces radiation 12, which is imaged onto the input slit of grating monochromator 13. The monochromator is controlled by a stepper motor to permit automatic wavelength selection. Substantially monochromatic light 14 exiting the output slit is chopped by mechanical chopper 15 and focused onto the core of fiber 17 by means of focusing optics 16, e.g. a 20×0.4 NA microscope objective. Use of such an objective assures excitation of all propagating modes in the fiber, since the NA of typical currently used single mode fibers is only of the order of 0.1. The fiber, of any length greater than about 1 meter, is held in place by means of fixtures 18. The far end of the fiber is positioned close to the axis of galvanometer scanner mirror 19, whose nominal position is at approximately 45 degrees from the axis of the fiber. Radiation detector 21, covered by infrared transmitting color glass filter 20 to block ambient light, is typically positioned several centimeters from the mirror. The detector, e.g. a 2-stage thermoelectrically cooled lead sulfide unit, advantageously is fitted with an aperture that is optimized for use in this application. I have found that a 1×4 millimeter aperture, arranged with its long dimension perpendicular to the scan direction, yields angular resolution sufficient for the practice of the method with apparatus such as shown in FIG. 2. However, in different instrumentation schemes it may be found advantageous to use different aperture geometries and/or dimensions.

The output of 21 is AC-coupled to a lock-in amplifier 22 for synchronous detection. A signal in phase with chopper 15 is fed to the reference input of 22. The analog output of 22 goes to digital voltmeter 24, e.g. a Hewlett-Packard 3437A system detector comprising, for instance, a PIN detector, is also mounted on the rotation stage which is driven by stepping motor. The output of the detector can be fed to a lock-in amplifier, together with a reference signal in phase with the radiation pulses.

According to the invention, a Gaussian function is to be fitted to the measured far-field data. An appropriate Gaussian function is G (θ) =G₀ exp (−θ²/20_{ω}²). where Go is the amplitude θ=0, and θ_{ω} is the “beam angle”. A preferred approach is to first determine the field amplitude distribution Eₘ(θ) from the measured power distribution. This can typically be done, at least in the central lobe of the distribution, by taking the square root of the measured values. It will be appreciated that the power distribution is typically measured at discrete angles, and that therefore Eₘ(θ) is also determined for discrete values of θ. The Gaussian function can be fitted to Eₘ(θ) by any appropriate curve-fitting technique, but maximizing the value of the overlap integral I, defined by Equation (1) below, by varying θ_{ω}is the preferred procedure.

$$I = \frac{{[ {\int }_{0}^{∞} θ G ( θ ) {E}_{m} ( θ ) ⅆ θ ]}^{2}}{{\int }_{0}^{∞} θ {G}^{2} ( θ ) ⅆ θ {\int }_{0}^{∞} θ {E}_{m}^{2} ( θ ) ⅆ θ} \qquad ( 1 )$$

The integration is typically performed numerically. Methods for numerical integration are well known. Fitting, the function G(θ) determines the beam angle θ_{107 .} and ω and/or λ_{c} can be determined from θ as will now be described.

The MFR ω is preferably determined by measuring the far-field power distribution at a wavelength in the single mode regime of the test fiber, forming Eₘ(θ) as described above, fitting G(θ) thereto, and determining ω by means of Equation (2) wherein λ is the radiation wavelength in a vacuum.

$$∞ = \frac{λ}{2 {πtanθ}_{∞}} \qquad ( 2 )$$

To determine λ_{c} by the instant method, it is necessary to measure the far-field power distribution as a function of wavelength from a wavelength substantially below to a wavelength substantially above the expected 80 _{c}.

The Anderson patent claims an optical fiber manufacturing process that includes design steps of determining the mode field radius as described above. Our experience shows that a more accurate estimate of the optical mode is obtained by using the Bessel function in place of the Gaussian estimate. More specifically, the Bessel function is a mathematical function used in the design of a filter for maximally constant time delay with little consideration for amplitude response. This function is very close to a Gaussian function.

By definition the solutions of Bessel's differential equation, Equation (3). Bessel functions, also called cylinder function, are examples of special functions which are introduced by a differential equation.

z²d²y/dz²°z dy/dz +(z^{3-z}³)y =0 . . . (3)

Bessel functions are of great interest in purely mathematical concepts and in mathematical physics. They constitute additional functions which, like the elementary functions z¹¹, sin, z, e, can be used to express physical phenomena.

Applications of Bessel functions are found in such representative problems as heat conduction or diffusion in circular cylinders, oscillatory motion of a sphere in a viscous fluid, oscillations of a stretched circular membrane, diffraction of waves by a circular cylinder of finite length or by a sphere, acoustic or electromagnetic oscillations in a circular cylinder of finite length or in a sphere, electromagnetic wave propagation in the waveguides of circular cross-section, in coaxial cables, or along straight wires, and in skin effect in conducting wires of circular cross section. In these problems, Bessel functions are used to represent such quantities as the temperature, the concentration, the displacements, the electric and magnetic field strengths, and the current density as function of space coordinates. The Bessel functions enter into all these problems because boundary values on circles (two-dimensional problems), on circular cylinders, or on spheres are prescribed, and the solutions of the respective problems are sought either inside or outside the boundary, or both.

Definition of Bessel functions. The independent variable z in Bessel's differential equation may in applications assume real or complex values. The parameter v is, in general, also complex. Its value is called the order of the Bessel function. Since there are two linearly independent solutions of a linear differential equation of the second order, there are two independent solutions of Bessel's differential equation. They cannot be expressed in finite form in terms of elementary functions such as z¹¹, sin, z, e^{Z} unless the parameter is one-half of an odd integer. They can, however, be expressed as power series with an exception for integer values of v . The function defined by Equation (4) is designated as Bessel's function of the first kind,

$${J}_{v} ( z ) = {( \frac{z}{2} )}^{v} {\sum }_{l = 0}^{∞} \frac{{( - {z}^{2} / 4 )}^{l}}{l ! Γ ( v + l + 1 )} \qquad ( 4 )$$

or simply the Bessel function or order v . Γ(v +l +1) is the gamma function. The infinite series in Equation (2) converges absolutely for all finite values, real or complex, of z. In particular, Equation (5) may be expressed.

$${J}_{0} ( z ) = 1 - \frac{1}{1 ! 1 !} {( \frac{z}{2} )}^{2} + \frac{1}{2 ! 2 !} {( \frac{z}{2} )}^{4} - \frac{1}{3 ! 3 !} {( \frac{z}{2} )}^{6} + … {J}_{1} ( z ) = \frac{z}{2} - \frac{1}{1 ! 2 !} {( \frac{z}{2} )}^{3} + \frac{1}{2 ! 3 !} {( \frac{z}{2} )}^{5} - … \qquad ( 5 )$$

Along with J_{V} (z), there is a second solution J_{-V} (z). It is linearly independent of J_{V} (z)

Other methods such as finite-element or finite-difference calculations are more general in that they are not restricted to cylindrical symmetries. However, they are more computationally intensive, often give spurious solutions, offer less analytic insight, and may be less able to locate all bound mode solutions.

Fiber optic technology is becoming increasingly important for high-speed optical communications, and understanding fiber modes is vital for developing new structures and fiber-optic based devices. Many computer mode solving applications for semiconductor waveguides and optical fibers are already on the market. This particular fiber mode-solver was developed after discussion with a colleague, Prof. Gary Evans, of Southern Methodist University, who had previously played a key role in the development of a planar-layer mode solver (‘MODEIG’) released in the public domain. The reduction to practice, implementation, and user interface of the present fiber mode-solver was done in the framework of another application environment, ‘Igor Pro’ (Wavemetrics, Inc.). It was our intent to have a student extend the above technique to lossy fiber media, and generalize the user interface in a stand-alone PC type application. Prof. Evans is now part of a commercial venture, Photodigm, Inc. that is interested in incorporating this type of fiber mode-solver in its suite of computer-aided engineering applications related to the photonics industry

While the invention has been described in its presently preferred embodiment, it is understood that the words which have been used are words of description rather than words of limitation and that changes within the purview of the appended claims may be made without departing from the scope and spirit of the invention in its broader aspects.

What is claimed is:

1. A cylindrical optical fiber manufacturing process comprising a multiplicity of manufacturing steps including forming a first optical fiber preform, drawing a first fiber from the first preform and grading of the drawn fiber, the process further comprising
determining the mode field radius ω for radiation of wavelength λ₀ of a segment of the first fiber, λ₀ being a wavelength in the single mode regime of the segment of the fiber, the fiber segment having a first and second end and being of length effective to produce steady-state propagating conditions at the second end for radiation of wavelength λ₀ launched into the first end;
comparing ω to a predetermined target value of the mode field radius;
setting at least one of the manufacturing steps in the manufacture of the first fiber, setting of at least one of the manufacturing steps for the subsequent production of another optical fiber, in accordance with the result of the comparison between ω and the target value;
the mode field radius ω determined by a method further comprising
(a) coupling substantially monochromatic measurement radiation of wavelength λ₀ into the first end of the fiber segment in a manner effective for launching the fundamental mode LP₀₁,
(b) measuring, as a function of a far-field angle θ, the radiation power at a multiplicity of values of θ in at least part of the central lobe of the far-field radiation field of the radiation emitted from the second end of said first fiber, the set of measured values of radiation power to be referred to as the radiation power distribution,
(c ) fitting a Bessel function to the radiation power distribution, or to a distribution derived from the radiation power distribution, and
(d) determining ω from the fitted Bessel function.

2. Single mode optical fiber manufacturing process comprising a multiplicity of manufacturing steps including forming an optical fiber preform, drawing a first fiber from the preform and grading of the drawn fiber, the process further comprising
determining an actual cut-off wavelength λ_{c} of a segment of the first fiber, where λ_{c} is the actual cut-off wavelength of the LP₁₁mode of electromagnetic radiation propagating axially through the segment of fiber, the fiber segment having a first and second end and having a length effective to produce steady-state propagation conditions at the second end for electromagnetic radiation launched into the first end and propagating axially through the segment; comparing λ_{c} to a predetermined target value;
setting at least one of the manufacturing steps in the manufacture of the first fiber, or setting of at least one of the manufacturing steps for the subsequent production of another optical fiber, in accordance with the result of the comparison between λ_{c} and the target value; the actual cut-off wavelength λ_{c} determined by a method further comprising:
(a) coupling substantially monochromatic measurement radiation of a first wavelength λ into the first end of the fiber segment in a manner effective for launching at least one propagating mode of radiation,
(b) measuring, as a function of a far-field angle θ, the radiation power at a multiplicity of values of θ in at least part of the central lobe of the far-field radiation field of the radiation emitted from the second fiber end, the set of measured values of radiation power to be referred to as the radiation power distribution at said λ.
(c ) fitting a Bessel function B_{λ}(θ) to the radiation power distribution at said λ, or to a distribution derived from the radiation power distribution at said λ,
(d) repeating steps (a), (b), and ( c ), at a multiplicity of radiation wavelengths different from the first wavelength, the wavelengths spanning a wavelength range than includes λ_{c}.
(e) the steps of (a), (b), ( c ) and (d) to be carried out on the fiber segment free of mode-stripping bends, and also on the fiber segment containing at least one mode-stripping bend, thereby determining a multiplicity of fitted Bessel functions, and
(f) determining λ_{c} of the fiber segment from the multiplicity of said fitted Bessel functions.
